(19) United States
(12) Patent Application Publication
(10) Pub. No.: US 2002/0143578 A1
(43) Pub. Date: Oct. 3, 2002

(54) Interactives system and method for recording and assessing a person's inherited risk for a range of diseases

(76) Inventors: Louis Scott Cole, Palo Alto, CA (US); Adam Lawrence Lowe, San Francisco, CA (US); Lawrence Michael Prensky, San Mateo, CA (US); Jennifer Susan Graham, Redwood City, CA (US); George Clement Morris JR., Campbell, CA (US); Ronald Charles Horn II, Poway, CA (US); John Norman Vig, Carlsbad, CA (US); Miriam Suzanne Komaromy, Hillsborough, CA (US); Kari L. Danziger, Foster City, CA (US); John Chul-Yong Shon, Palo Alto, CA (US)

Correspondence Address: Brian S. Rosenbloom, Esquire, Mintz Levin Cohn Ferris Glovsky and Popeo PC, Suite 400, 11911 Freedom Drive, Reston, VA, 20190, US

(21) Appl. No.: 09/864,700

(22) Filed: May 24, 2001

Related U.S. Application Data
(60) Provisional application No. 60/280,780, filed on Apr. 2, 2001.

(51) Int. Cl. G06F 17/60

(52) U.S. Cl. 705/2

(57) ABSTRACT

A system for recording and assessing a person's inherited risk for disease. The system comprises a server for communicating with a communication device used by the person. The server comprises a risk assessment program that performs a risk assessment process. The process comprises the steps of: querying the person for family history information, receiving family history information inputted by the person, generating a family tree diagram based on the received family history information, transmitting the diagram to the communication device, querying the person for family medical history information concerning members of the person's family, receiving the family medical history information, generating a family medical tree diagram based on the received family medical history information, transmitting the diagram to the communication device, receiving a request to generate a risk assessment report, generating the risk assessment report, and transmitting it to the communication device.

This application claims the benefit of U.S. Provisional Patent Application No. 60/280,780, filed Apr. 2, 2001, the entire contents of which are incorporated herein by this reference.

### BACKGROUND OF THE INVENTION

1. Field of the Invention

The present invention is generally related to medical risk assessment systems, and, more specifically, to an interactive system and method for recording and assessing a person's inherited risk for a range of diseases.

2. Discussion of the Background

Human genetic and genomic discovery is progressing at breakneck speed. New knowledge concerning the role genetics plays with respect to common diseases and new genetic tests will make genetics a ubiquitous aspect of medicine relevant to every disease area and medical specialty. A major benefit of this genetic revolution is our increased ability to perform risk assessments. Nearly 40% of the population is at increased risk for a common disease. Unfortunately, today's genetic services infrastructure, particularly with regard to performing risk assessments, is insufficient to address the rapidly growing need of ordinary individuals to assess and manage their risks. Primary care and other physicians are not a reliable source of genetic services because of inadequate training, difficulty in keeping abreast of new developments, and time and budgetary constraints imposed by managed care.

What is desired, therefore, is a source of high quality information and personalized services to help the public understand and take advantage of new medical genetic knowledge.

### SUMMARY OF THE INVENTION

An object of the invention is to overcome at least some of the above identified problems and disadvantages.

In one aspect, the invention provides a system for recording and assessing a person's inherited risk for one or more diseases. The system comprises a server, which is connected to a network, for communicating with a communication device that is used by the person. The server comprises a risk assessment program that performs a risk assessment process. The process comprises the steps of: querying the person for the person's family history information, receiving family history information inputted by the person, generating a family tree diagram based on the received family history information, transmitting the family tree diagram to the person's communication device, querying the person for family medical history information concerning members of the person's family (including the person him or herself), receiving the family medical history information inputted by the person, generating a family medical tree diagram based on the received family medical history information, transmitting the family medical tree diagram to the person's communication device, receiving a request to generate a risk assessment report that assesses the person's inherited risk for one or more diseases based at least in part on the received family medical history information, generating the risk assessment report, and transmitting the risk assessment report to the person's communication device.

Preferably, the server is a web server and the network that connects the person's communication device to the server is the Internet. An advantage of this feature is that any member of the public who has Internet access and a communication device with a web browser installed can get a diagram of the person's family medical tree and a report that assesses his or her inherited risk for disease.

The invention also provides a system for assessing a person's inherited risk for a disease, wherein the system comprises a communication device having a user interface for allowing the person to receive and input information, a server, and a network for allowing the communication device to communicate with the server. The server executes a risk assessment program that comprises a tree-creation module for generating a family medical tree diagram based on family medical history information inputted by the person into the communication device and received by the risk assessment program, and a risk assessment module for generating a risk assessment report that assesses the person's inherited risk for a disease based on the family medical history information.

The invention also provides a method for assessing inherited risk for a user having access to a communication device that is equipped to communicate with a server through a network, wherein the user may be any member of the public. The method comprises the steps of: transmitting from the server to the communication device a first form that enables the user to input family history information and transmit the inputted information to the server, generating a family tree diagram based on family history information inputted by the user if the user indicates that the user desires to view the family tree diagram, transmitting from the server to the communication device a second form that enables the user to input family medical history information and transmit the inputted information to the server, generating a family medical tree diagram based on family medical history information inputted by the user if the user indicates the user desires to view the family medical tree diagram, receiving from the communication device an indication that the user desires to have a risk assessment report generated that assesses the user's inherited risk for one or more diseases, generating, in response to receiving the indication, a risk assessment report based on family medical history information inputted by the user, and transmitting the risk assessment report to the user.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. Additionally, the left-most digit(s) of a reference number identifies the drawing in which the reference number first appears.

FIG. 1 illustrates a system for enabling any member of the public to assess his or her inherited risk for one or more diseases.

FIG. 2 illustrates an example family tree diagram.

FIG. 3 illustrates an example family medical tree diagram.

FIG. 4 illustrates an example home page.

FIGS. 5A-C is a flow chart illustrating a process, according to one embodiment, for producing a risk assessment report.

FIGS. 6-8 illustrate example electronic forms that are transmitted to a user to assist the user in entering his or her family history information.

FIG. 9 shows an example electronic form that may be sent to the user and that asks user to indicate which of the user's relatives on the user's father's side of the family have a history of cancer.

FIGS. 10-12 illustrate example forms that query the user for additional medical history information for a family member that was indicated by the user as having a history of cancer.

FIGS. 13A-B, 14, and 15 illustrate additional example forms that may be transmitted to the user for the purpose of collecting medical history information from the user.

### DETAILED DESCRIPTION OF THE PREFERRED EMBODIMENTS

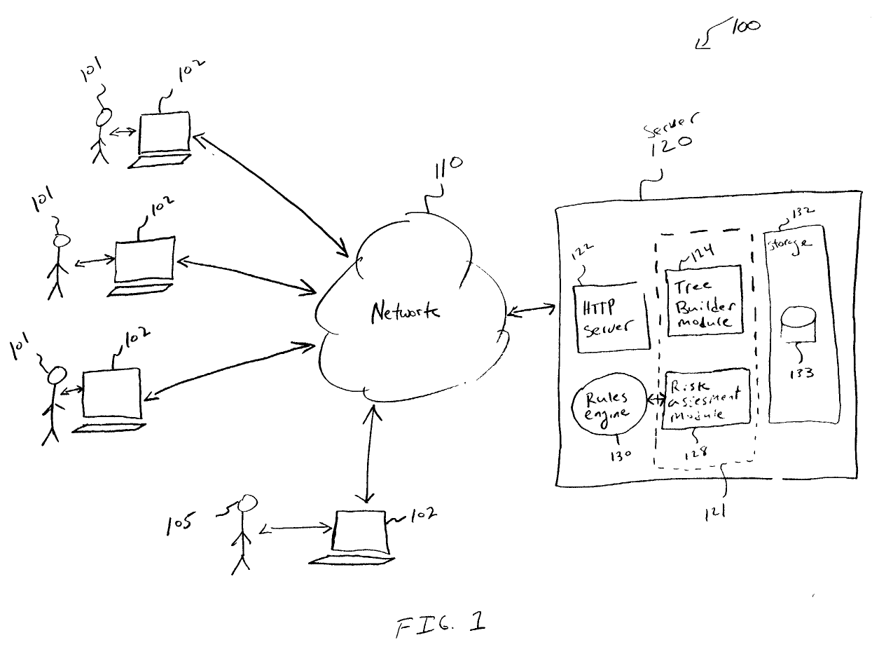

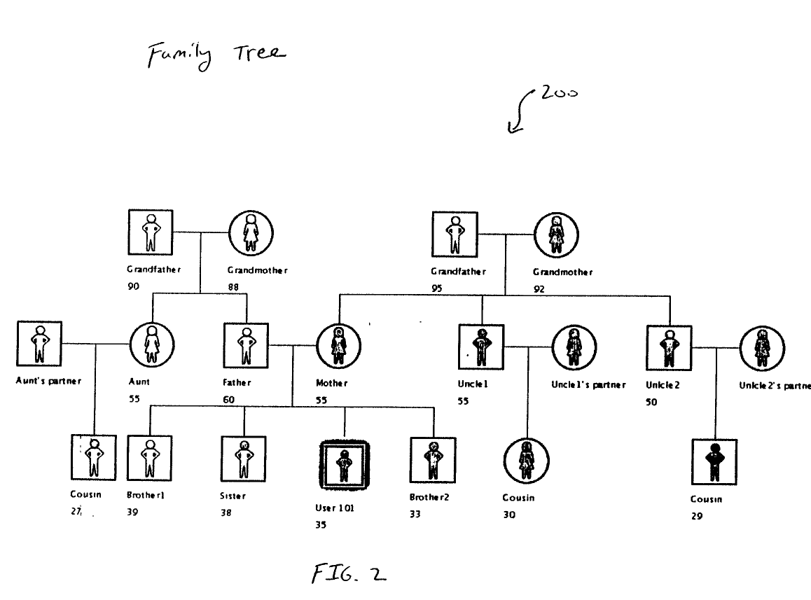

FIG. 1 illustrates a system 100 for enabling any member of the public (hereafter user 101), who has access to a communication device 102 that is capable of communicating with a server 120 through a network 110, to assess his or her inherited risk for a range of diseases.

Server 120 is operable to generate a risk assessment report for any user 101. The generated risk assessment report assesses the user's inherited risk for one or more diseases, such as, for example, many forms of cancer, heart disease, prenatal diseases, diabetes, hemochromAtosis, Alzheimer's disease, etc. User 101 can have server 120 generate a personal risk assessment report by using communication device 102 to connect to server 120 and by interacting with a risk assessment program 121 that runs either on server 120 (or on a different computer that communicates with server 120). In addition to generating a risk assessment report tailored for user 101, server 120 is also operable to generate a risk assessment report concerning user 101 that is tailored for use by a health care professional 105. Thus, server 120 may create two risk assessment reports for user 101, one that is tailored for user 101 and one that is tailored for a health care professional 105.

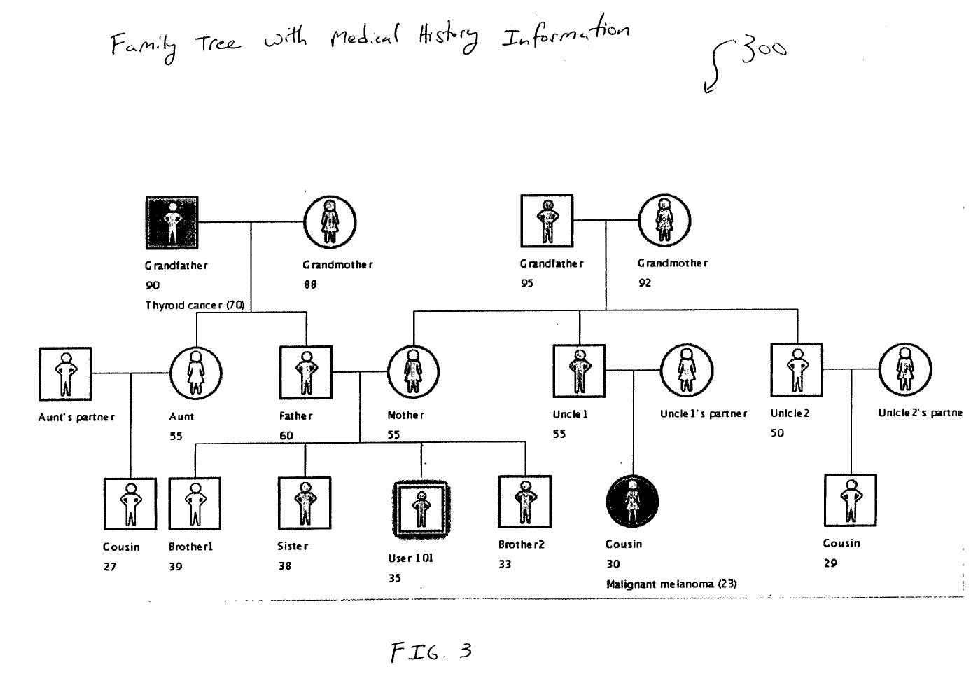

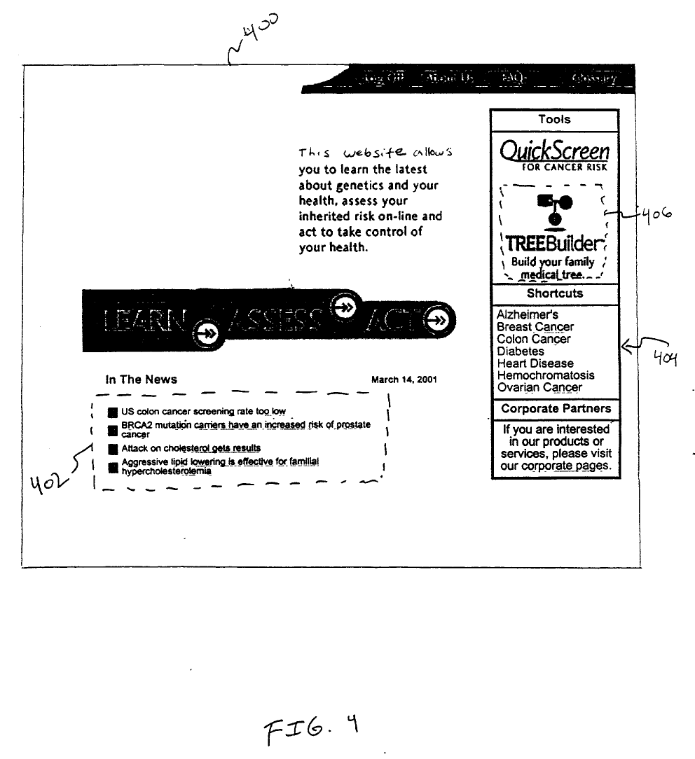

Risk assessment program 121 includes a tree-creation module 124 and a risk assessment module 128. Tree-creation module prompts user 101 to enter family history information, generates a family tree diagram based on the family history information entered by user 101, and transmits the family tree diagram to the user's communication device 102. The module 124 also prompts user 101 to enter medical history information for each person displayed in the family tree diagram, generates an updated family tree diagram that reflects some or all of the medical history information entered by user 101, and transmits the updated family tree diagram (also referred to as the “family medical tree diagram”) to the user's communication device 102. FIG. 2 illustrates an example family tree diagram 200 and FIG. 3 illustrates an example family medical tree diagram 300.

As shown in FIG. 3, family medical tree diagram 300 highlights the family members that have been diagnosed with a disease and provides information concerning when the diagnoses was made and the name of the disease diagnosed. For example, as shown in FIG. 3, user 101's paternal grandfather is highlighted and one of user 101's cousin in highlighted. Tree 300 indicates that the paternal grandfather was 70 years old when he was diagnosed with Thyroid cancer and tree 300 indicates that the cousin was diagnosed with malignant melanoma at age 23.

After inputting medical history information, user 101 can request risk assessment module 128 to assess the user's inherited risk for one or more diseases (e.g., heart disease, cancer, diabetes, Alzheimer's, etc). Risk assessment module 128 uses a rules engine 130 and the family information and the medical history information entered by user 101 to produce a risk assessment report for user 101. Specifically, risk assessment module 128 passes user 101's pertinent family medical history information to rules engine 130, which includes a set of previously defined rules. These rules define different patterns which indicate independently or in combination a certain risk level. Rules engine 130 evaluates the family medical history information against the predefined set of rules and outputs a list of rules that have fired. Risk assessment module 128 receives this list and generates one or more risk reports (e.g., one risk report tailored for user 101 and one risk report tailored for health care professional 105) based on which rules fired. The risk report(s) are stored in database 133 for review and/or download by user 101.

After downloading the risk assessment report(s), user 101 may then take the risk assessment report(s) and a printed copy of the family medical tree diagram to health care professional 105. Health care professional 105 can appropriately advise the user 101 based on the user's risk assessment report(s) and family medical tree diagram.

An example embodiment of the invention will now be described in more detail. As is evident to one skilled in the art, the specific embodiment described below is just one way possible way to implement the present invention and serves merely to illustrate the invention and not to limit the invention. In the example embodiment described below, server 120 implements a web site and includes a hypertext transfer protocol (HTTP) server 122 for communicating with a conventional web browser that is installed in communication device 102. Additionally, for the sake of brevity, the example is mainly directed to creating a risk assessment report for only one disease, cancer. However, one skilled in the art will appreciate that the invention is not limited to any one particular disease.

When user 101 connects to a predetermined port on server 120 using communication device 102, server 120 transmits a user interface page 400 (also referred to as home page 400) (see FIG. 4) to communication device 102, which then displays page 400 to user 101. Home page 400 preferably includes a number of links 402-404 to sources of healthcare related information. Home page 400 also includes a link 406 to risk assessment program 121.

After user 101 selects link 406, server 120 transmits a log-on form. On this form, user 101 may enter his or her username and password so that user 101 can be authenticated by server 120. If user 101 does not have a username, user 101 may register with the system 100 to get one. After server 120 authenticates user 101, user 101 may take advantage of the features of risk assessment program 121. For example, user 101 can use risk assessment program 121 to generate a risk assessment report that assesses the user's inherited risk for one or more diseases.

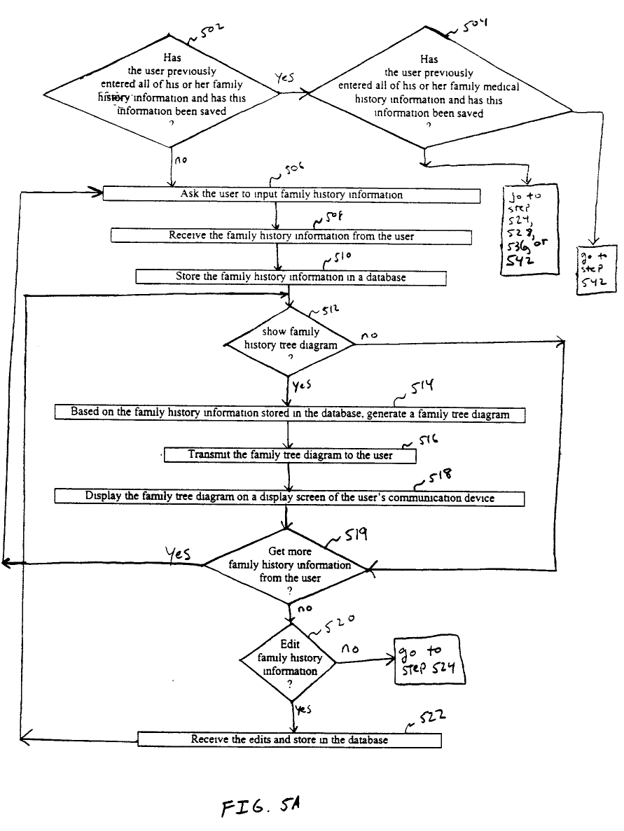

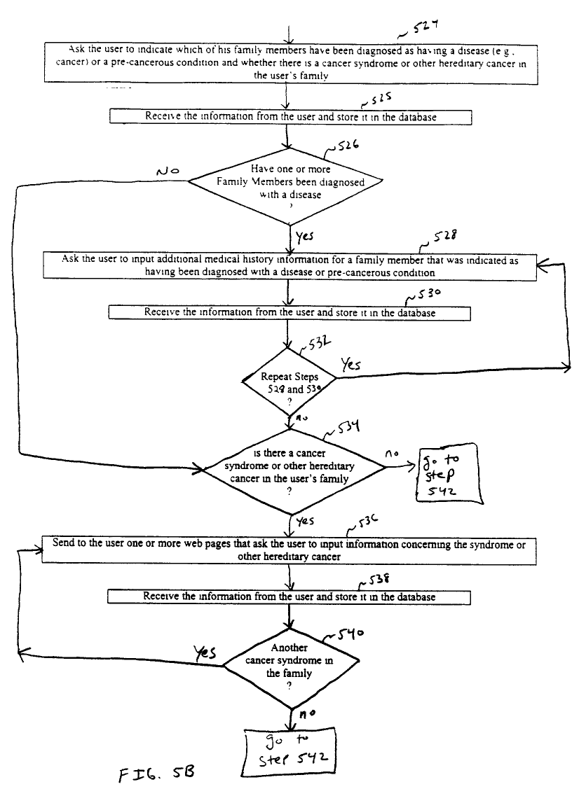

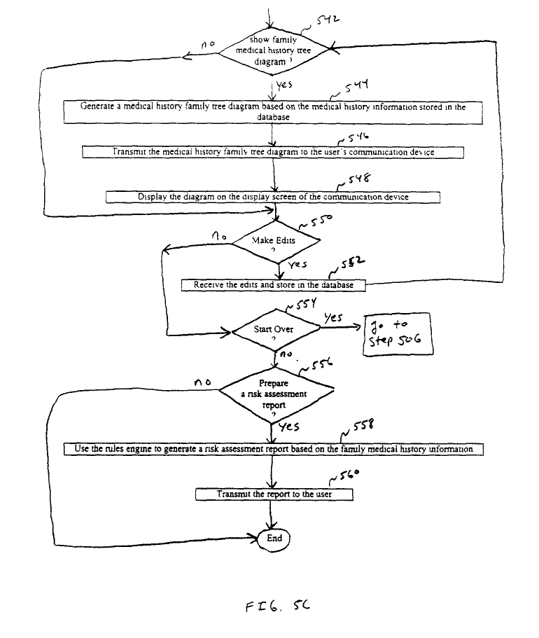

A flow chart illustrating a process 500, according to one embodiment, for producing a risk assessment report for a user 101 after user 101 is authenticated is shown in FIGS. 5A-5C. As shown in FIG. 5A, process 500 begins in step 502 where a determination is made as to whether user 101 has previously transmitted to server 120 all of his or her family history information and whether this information is stored in database 133. If yes, control passes to step 504, otherwise control passes to step 506. In step 504, a determination is made as to whether user 101 has previously transmitted to server 120 all of his or her family medical history information and whether this information is stored in database 133. If yes, control passes to step 542, otherwise control passes to step 524, 528, 536, or 542 depending on the last piece of information that was received from user 101 and stored in database 133.

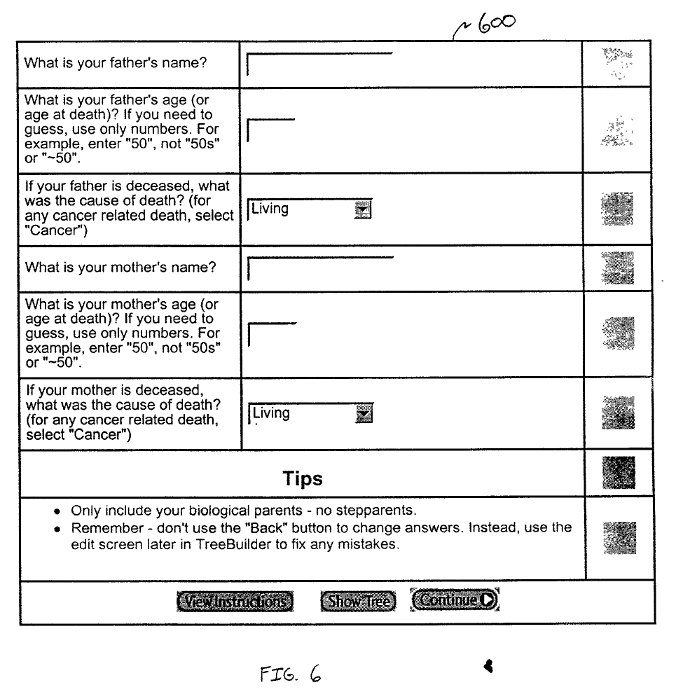

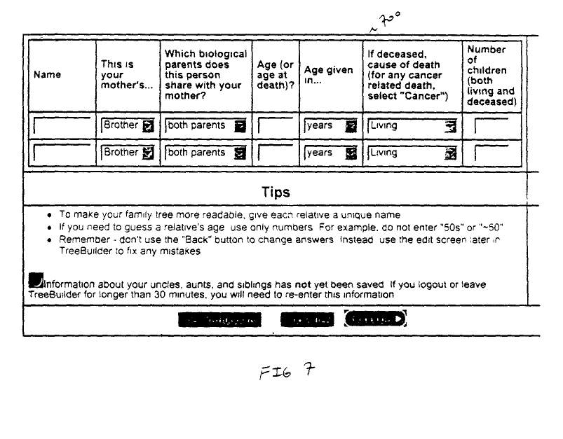

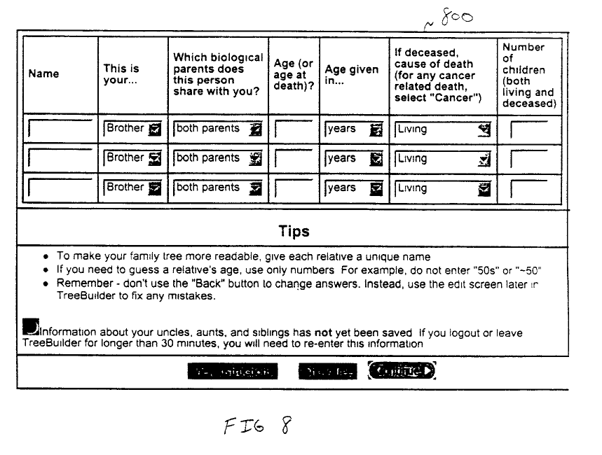

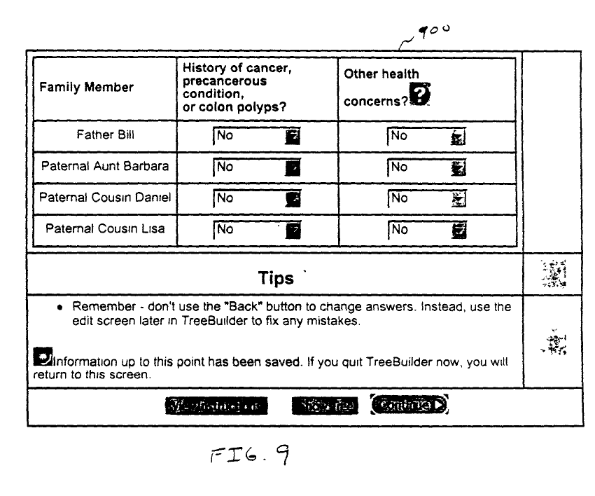

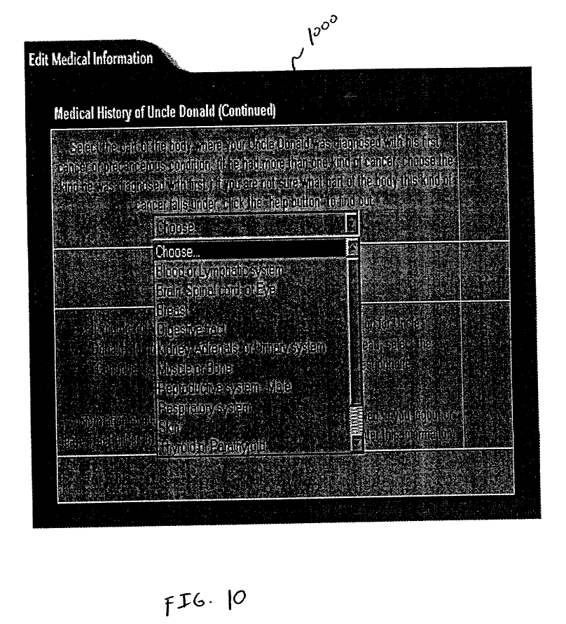

Referring now to step 506, in step 506, risk assessment program 121 asks user 101 to input family history information. For example, user 101 is prompted to enter information (e.g., name, age, sex, etc.) concerning him or herself and his or her “family members” (i.e., his or her parent, grandparents, siblings, aunts, uncles, cousins, nieces, and nephews). FIGS. 6-8 illustrate example electronic forms 600, 700, and 800, respectively, that are transmitted to user 101 to assist user 101 in entering his or her family history information. For example, form 600 prompts user 101 for information regarding his or her parents, and form 800 prompts user 101 for information concerning his or her siblings. In one embodiment, electronic forms 600, 700, and 800 are implemented as web pages.

After user 101 enters some family history information, the information is transmitted to server 120 where it is received (step 508). After receiving the family history information, the information is stored in database 133 and associated with user 101 (step 510), so that if at another point in time user 101 desires to receive a risk assessment report user 101 need not resubmit family history information that was previously submitted. After step 510, control passes to step 512.

In step 512, user 101 is given the choice to view a family tree diagram based on the family history information received in step 508. If the user chooses to view the family tree diagram control passes to step 514, otherwise control passes to step 519. In step 514, tree-creation module 124 generates a family tree diagram based on user 101's family history information stored in database 133 (see FIG. 2 for an example family tree diagram). In one embodiment, the diagram is a digitized compressed image, such as a GIF, TIFF, JPEG, PNG, or other like image, of the family tree. This family tree diagram is then transmitted to user 101's communication device (step 516), which displays the received family tree diagram to user 101 (step 518). The generated family tree diagram may also be stored in database 133. After step 518, control passes to step 519.

In step 519, risk assessment program 121 determines whether to ask user 101 to input more family history information. If risk assessment program 121 determines that it should ask user 101 to input more family history information, control passes back to step 506, otherwise control passes to step 520. In one embodiment, in step 506, program 121 does not ask user 101 to enter all of his or her family history information. Thus, in this embodiment, step 506 is executed more than once. For example, the first time step 506 is executed, program 121 only asks user 101 to input family history information concerning user 101's parents, and the next time step 506 is executed, program 121 may ask user 101 to input family history information concerning user 101's siblings.

In step 520, user 101 is given the choice to edit the family history information that is stored in database 133. If user 101 chooses not to edit the family history information control passes to step 524, otherwise user 101 edits the information and the updated information is received by the risk assessment program 121 and stored in database 133 (step 522). After step 522, control passes back to step 512.

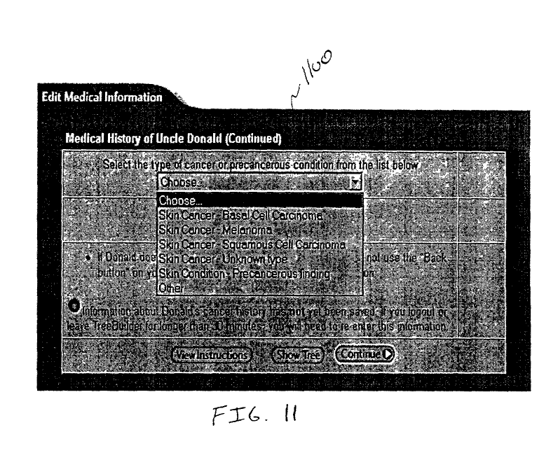

In step 524, risk assessment program 121 asks user 101 to enter family medical history information. That is, user 101 is asked to input his or her medical history information as well as medical history information for his or her family members. Additionally, program 121 asks user 101 to indicate whether there is a cancer syndrome or other hereditary cancer in user 101's family. For example, user 101 is asked, among other things, to indicate which of his or her family members have a history of a disease. For illustration, FIG. 9 shows an example form (e.g., web page) 900 that may be sent to user 101 and that asks user 101 to indicate which of user 101's relatives on user 101's father's side of the family have a history of cancer. The information entered by user 101 in response to the questions asked in step 524 is received by program 121 and stored in database 133 (step 525). After step 525, control passes to step 526.

In step 526, program 121 determines whether user 101 has indicated that one or more of his or her family members have been diagnosed with a disease. If one or more of user 101's family members have been diagnosed with a disease control passes to step 528, otherwise control passes to step 534.

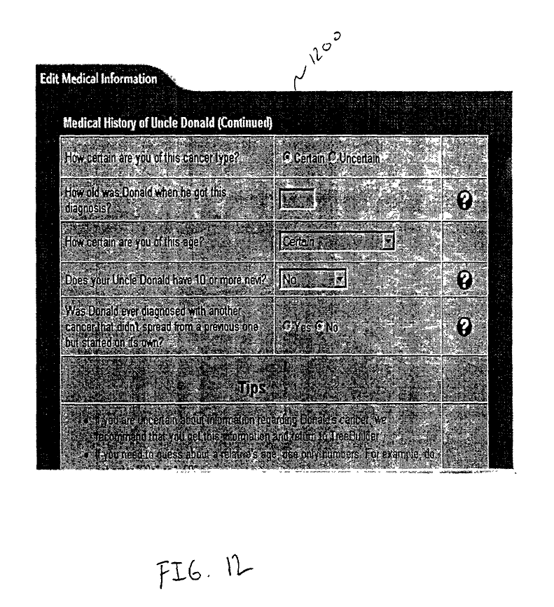

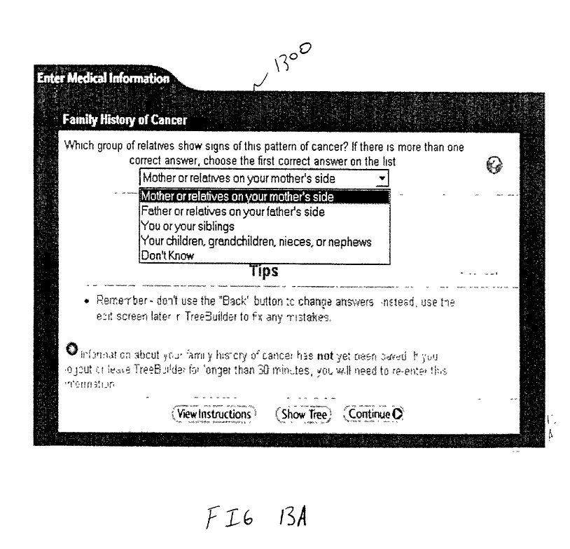

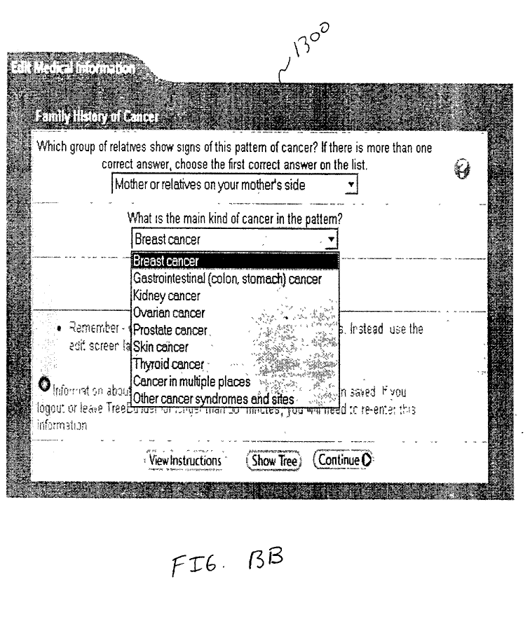

In step 528, program 121 transmits one or more forms that query user 101 for additional medical history information for a family member that was indicated by user 101 as having a history of cancer. An example of such forms are illustrated in FIGS. 10, 11, 12. For instance, a form 1000 (see FIG. 10) is sent to user 101 if user 101 indicates that a family member has been diagnosed with cancer or a pre-cancerous condition. As shown in FIG. 10, form 1000 asks user to identify the part of the body where the family member was diagnosed with his or her first cancer or pre-cancerous condition. After user identifies the part of the body, program 121 transmits form 1100 (see FIG. 11) to user 101.

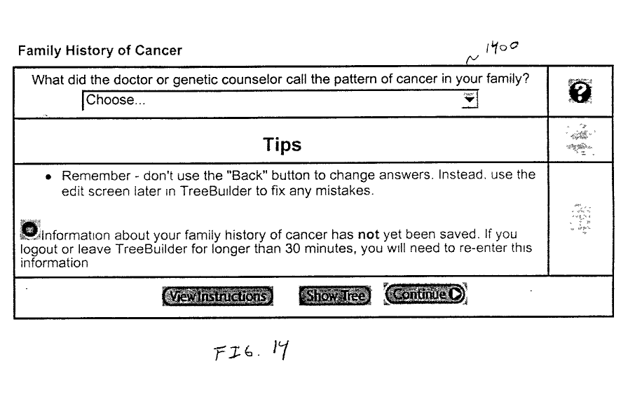

Web page 1100 presents user 101 with a list of cancers and asks user 101 to identify the cancer that the family member was diagnosed as having. After user 101 identifies the diagnosed cancer, program 121 transmits form 1200 (see FIG. 12) to user 101. Form 1200 asks user 101 the following general questions: (1) whether the user is certain or uncertain of the diagnosed cancer; (2) how old was the family member when he or she was diagnosed; (3) how certain is the user of this age; and (4) whether the family member was ever diagnosed with another cancer that didn't spread from a previous one but started on its own. Depending on the type of cancer the family member was diagnosed as having, form 1200 may ask specific cancer related questions. For example, if user 101 indicates that the family member was diagnosed with melanoma, form 1200 may ask whether the family member has 10 or more nevi.

If in answering question (4) from above, user 101 indicates that the family member was diagnosed with another cancer that didn't spread from a previous one but started on its own, step 528 is repeated for that family member.

The information entered by user 101 in response to the questions asked in step 528 is received by program 121 and stored in database 133 (step 530). After step 530, control passes to step 532. In step 532, program 121 determines whether it needs to repeat steps 528 and 530 for a different family member. Program 121 repeats steps 528 and 530 for each family member that was indicated as having been diagnosed with a disease. If program 121 determines that it should repeat steps 528 and 530 for a different family member, control passes back to step 528, otherwise control passes to step 534.

In step 534, program 121 determines whether there is a cancer syndrome or other hereditary cancer in user 101's family based on user 101's input in step 524. If there is a cancer syndrome or other hereditary cancer in user 101's family, control passes to step 536, otherwise control passes to step 542.

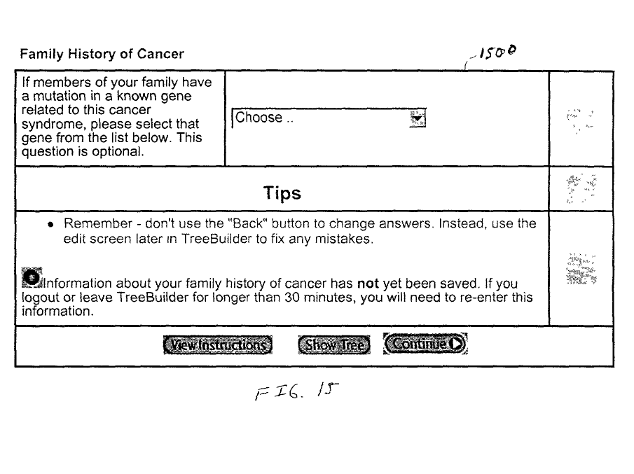

In step 536, program 121 asks user 101 to enter information concerning the cancer syndrome or hereditary cancer. For example, program 121 may transmit to user 101 one or more forms that prompt user 101 to enter information concerning the cancer syndrome or hereditary cancer. FIGS. 13A-B, 14, and 15 illustrate example forms 1300, 1400, and 1500, respectively, that may be transmitted to user 101. As shown in FIGS. 13A and 13B, form 1300 asks user 101 to (1) select a group of relatives from a list that show signs of the cancer syndrome or hereditary cancer, and (2) select the main kind of cancer from a given list of cancers. After user 101 makes the selections, program 121 transmits form 1400 to user 101. Form 1400 asks user 101 for information concerning what a doctor or genetic health counselor called the cancer syndrome (if anything). Form 1400 provides user 101 with a list of cancer pattern types (not shown) from which to make a selection. If user 101 selects one of the listed cancer pattern types, program 121 transmits form 1500 to user 101. Form 1500 asks user 101 to select a gene from a given list if members of user 101's family have a mutation in the gene. The information entered and/or selected by user 101 in response to the questions asked in step 534 is received by program 121 and stored in database 133 (step 538).

After step 538, control passes to step 540. In step 540, program 121 asks whether there is another pattern of cancer in user 101's family. If there is, control passes back to step 536, otherwise control passes to step 542.

In step 542, user 101 is given the choice to view a family medical tree diagram based on the family medical history information entered or selected by user 101 in the above steps. If the user chooses to view the family medical tree diagram, control passes to step 544, otherwise control passes to step 550. In step 544, tree-creation module 124 generates a family medical tree diagram based on user 101's family medical history information stored in database 133 (see FIG. 3 for an example family medical tree diagram). In one embodiment, the diagram is a digitized compressed image, such as a GIF, TIFF, JPEG, PNG, or other like image, of the family medical tree. This family medical tree diagram is then transmitted to user 101's communication device (step 546), which displays the received family tree diagram to user 101 (step 548). The generated family medical tree diagram may also be stored in database 133. After step 548, control passes to step 550.

In step 550, user 101 is given the choice to make changes to any of the information user 101 has entered. If user 101 chooses not to make any edits, control passes to step 554, otherwise user 101 makes the desired edits and the updated information is received by the risk assessment program 121 and stored in database 133 (step 552). After step 552, control passes back to step 542.

In step 554, user 101 is given the option to start over. If user 101 chooses to start over, control passes back to step 506, otherwise control passes to step 556. In step 556, program 121 provides user 101 with the option of receiving a risk assessment report. If user 101 indicates that he or she wants a risk assessment report, control passes to step 558, otherwise process 500 ends. In step 558, as described above, risk assessment module 128 uses rules engine 130 and user 101's family medical history information that is stored in database 133 to generate a risk assessment report that assesses user 101's inherited risk for one or more diseases. After generating the risk assessment report, program 121 may transmit the report to user 101 (step 560). After step 560, process 500 ends.

Referring back to FIG. 1, communication device 102 is, preferably, a personal computer configured with a network interface or modem or other similarly configured computing device, but one skilled in the art will appreciate that other communication devices are contemplated, such as mobile phones, personal digital assistants (PDAs), laptop computers, etc. Similarly, network 110 is, preferably, the Internet or Public Switched Telephone Network (PSTN), but one skilled in the art will appreciate that other networks are contemplated (for example, local area networks (LANs) or wide area networks (WANs)).

While various embodiments/variations of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A system for assessing a person's inherited risk for disease, comprising a server, which is connected to a network, for communicating with a communication device that is used by the person, the server comprising a risk assessment program that performs a method comprising the steps of:
querying the person for the person's family history information;
receiving family history information inputted by the person;
generating a family tree diagram based on the received family history information;
transmitting the family tree diagram to the person's communication device;
querying the person for family medical history information concerning members of the person's family;
receiving the family medical history information inputted by the person;
generating a family medical tree diagram based on the received family medical history information;
transmitting the family medical tree diagram to the person's communication device;
receiving a request to generate a risk assessment report that assesses the person's inherited risk for one or more diseases based at least in part on the received family medical history information;
generating the risk assessment report; and
transmitting the risk assessment report to the person's communication device.

2. The system of claim 1, wherein the step of querying the person for the person's family history information includes the step of transmitting from the server to the communication device one or more web pages that enable the person to enter the person's family history information and transmit the inputted information to the server.

3. The system of claim 1, wherein the method further comprises the step of storing the received family history information in a database.

4. The system of claim 1, wherein the step of generating the family tree diagram includes the step of creating a graphics image file of the family tree diagram.

5. The system of claim 1, wherein the step of querying the person for family medical history information concerning members of the person's family includes the step of transmitting from the server to the communication device a web page that enable the person to enter family medical history information and transmit the inputted information to the server.

6. The system of claim 5, wherein the web page enables the person to indicate that a member of the person's family has been diagnosed with one or more diseases or one or more conditions.

7. The system of claim 6, wherein the one or more diseases include cancer, diabetes, Alzheimer's, and/or heart disease and the one or more conditions include a pre-cancerous condition.

8. The system of claim 7, wherein, if the person indicates that a member of the person's family has been diagnosed with cancer or a pre-cancerous condition, the step of querying the person for family medical history information concerning members of the person's family further includes the step of asking the person to select the part of the body where the member of the person's family was diagnosed with the cancer or pre-cancerous condition.

9. The system of claim 8, wherein, if the person indicates that a member of the person's family has been diagnosed with cancer or a pre-cancerous condition, the step of querying the person for family medical history information concerning members of the person's family further includes the step of asking the person to select from a list of cancer types the type of cancer or pre-cancerous condition for which the family member was diagnosed.

10. The system of claim 9, wherein, if the person indicates that a member of the person's family has been diagnosed with cancer or a pre-cancerous condition, the step of querying the person for family medical history information concerning members of the person's family further includes the step of enabling the person to indicate whether he or she is certain or uncertain of the type of cancer selected.

11. The system of claim 6, wherein if the person indicates that a member of the person's family has been diagnosed with one or more diseases or one or more conditions, the generated family medical tree diagram highlights the member of the person's family.

12. A system for assessing a person's inherited risk for a disease, comprising:
a communication device having a user interface for allowing the person to receive and input information;
a server;
a network for allowing the communication device to communicate with the server, wherein
the server executes a risk assessment program comprising:
a tree-creation module for generating a family medical tree diagram based on family medical history information inputted by the person into the communication device and received by the risk assessment program; and
a risk assessment module for generating a risk assessment report that assesses the person's inherited risk for a disease based on the family medical history information.

13. The system of claim 12, wherein the network is the Internet.

14. The system of claim 13, wherein the communication device includes a web browser.

15. The system of claim 14, wherein the server includes a hypertext transfer protocol (HTTP) server program for communicating with the web browser.

16. The system of claim 15, wherein the risk assessment program is operable to transmit to the communication device one or more web pages that enable the person to input his or her family history information and to transmit the inputted information to the server.

17. The system of claim 16, wherein the risk assessment program is further operable to transmit to the communication device one or more web pages that enable the person to input his or her family medical history information and to transmit the inputted information to the server.

18. The system of claim 17, wherein the server has access to a database for storing the family history information and the family medical history information.

19. A method for assessing inherited risk for a user having access to a communication device that is equipped to communicate with a server through a network, comprising the steps of:
transmitting from the server to the communication device a first form that enables the user to input family history information and transmit the inputted information to the server;
generating a family tree diagram based on family history information inputted by the user if the user indicates that the user desires to view the family tree diagram;
transmitting from the server to the communication device a second form that enables the user to input family medical history information and transmit the inputted information to the server;
generating a family medical tree diagram based on family medical history information inputted by the user if the user indicates the user desires to view the family medical tree diagram;
receiving from the communication device an indication that the user desires to have a risk assessment report generated that assesses the user's inherited risk for one or more diseases;
generating, in response to receiving the indication, a risk assessment report based on family medical history information inputted by the user; and
transmitting the risk assessment report to the user.

20. The method of claim 19, wherein the family tree diagram is a graphics image.

21. The method of claim 20, wherein the family tree diagram is one of a GIF, TIFF, PNG, and JPEG graphics image.

22. The method of claim 19, wherein the first form is a web page.

23. The method of claim 19, wherein the second form enables the user to indicate that a member of the user's family has been diagnosed with one or more diseases or one or more conditions.

24. The method of claim 23, wherein the one or more diseases includes cancer, diabetes, Alzheimer's, and/or heart disease and the one or more conditions include a pre-cancerous condition.

25. The method of claim 24, wherein, if the user indicates that a member of the user's family has been diagnosed with cancer or a pre-cancerous condition, the method further includes the step of transmitting from the server to the communication device a third form that enables the user to select the part of the body where the member of the user's family was diagnosed with the cancer or pre-cancerous condition.

26. The method of claim 25, wherein, the third form further enables the user to select from a list of cancer types the type of cancer or pre-cancerous condition for which the family member was diagnosed.

27. The method of claim 26, further comprising the step of transmitting from the server to the communication device a fourth form that enables the user to indicate whether he or she is certain or uncertain of the type of cancer selected from the list.

28. A system for assessing inherited risk for a user having access to a communication device that is equipped to communicate with a server through a network, wherein the server comprises:
a first form that enables the user to input family history information and transmit the inputted information to the server;
means for transmitting the first form to the communication device;
means for generating a family tree diagram based on family history information inputted by the user;
a second form that enables the user to input family medical history information and transmit the inputted information to the server;
means for transmitting the second form to the communication device means for generating a family medical tree diagram based on family medical history information inputted by the user;
means for receiving from the communication device an indication that the user desires to have a risk assessment report generated that assesses the user's inherited risk for one or more diseases;
means for generating a risk assessment report based on family medical history information inputted by the user; and
means for transmitting the risk assessment report to the user.

29. The system of claim 28, wherein the family tree diagram is a graphics image.

30. The system of claim 29, wherein the family tree diagram is one of a GIF, TIFF, PNG and JPEG graphics image.

31. The system of claim 28, wherein the first form is a web page.

32. The system of claim 28, wherein the second form enables the user to indicate that a member of the user's family has been diagnosed with one or more diseases or one or more conditions.

33. The system of claim 32, wherein the one or more diseases includes cancer, diabetes, Alzheimer's, and/or heart disease and the one or more conditions include a pre-cancerous condition.

34. The system of claim 33, wherein the server further comprises a third form that enables the user to select a part of the body where a member of the user's family was diagnosed with a cancer or pre-cancerous condition.

35. The system of claim 34, wherein the third form further enables the user to select from a list of cancer types the type of cancer or pre-cancerous condition for which the family member was diagnosed.

36. The system of claim 35, wherein the server further comprises a fourth form that enables the user to indicate whether he or she is certain or uncertain of the type of cancer selected from the list.
